(19) United States
(12) Patent Application Publication
(10) Pub. No.: US 2025/0079740 A1
(43) Pub. Date: Mar. 6, 2025

(54) ELECTRIC CONNECTOR AND CONNECTOR ASSEMBLY

(71) Applicant: HIROSE ELECTRIC CO., LTD., Kanagawa (JP)

(72) Inventor: Kouhei ODA, Kanagawa (JP)

(21) Appl. No.: 18/796,483

(22) Filed: Aug. 7, 2024

(30) Foreign Application Priority Data
Sep. 4, 2023 (JP) 2023-142882

(51) Int. Cl. H01R 13/11; H01R 13/502

(52) U.S. Cl. CPC H01R 13/11; H01R 13/502

(57) ABSTRACT

Provided is an electric connector including a terminal; and a housing, the terminal has a first leg portion, a second leg portion, a third leg portion, a fourth leg portion, an extending portion, a first coupling portion, a second coupling portion, a third coupling portion, a mount portion, a fitting recessed portion, and a width changing portion, the first leg portion, the first coupling portion, the second leg portion, and the housing filled in a space surrounded by them are integrally displaceable and the third leg portion, the third coupling portion, the fourth leg portion, and the housing filled in a space surrounded by the them are integrally displaceable, and the width changing portion is provided at least one of the second leg portion or the third leg portion so as to be exposed from the housing, and a width of the terminal changes at the width changing portion.

### CROSS-REFERENCE TO RELATED APPLICATION

This application claims priority from Japanese Patent Application No. 2023-142882 filed with the Japan Patent Office on Sep. 4, 2023, the entire content of which is hereby incorporated by reference.

### BACKGROUND

### 1. Technical Field

The present disclosure relates to an electric connector and a connector assembly.

### 2. Related Art

Conventionally, there have been known various techniques related to an electric connector for, e.g., connection of a printed circuit board or a flexible flat cable, which has a terminal and a housing. For example, JP-A-2017-69133 discloses an electric connector including a housing having a terminal housing portion opened upward in an upper-lower direction (fitting direction) and a bottom portion located on the lower side of the terminal housing portion and a terminal having a base portion embedded and held in the bottom portion of the housing, a spring portion extending upward of the base portion and elastically deformably housed in the terminal housing portion, and a contact portion supported by the spring portion.

In the electric connector disclosed in JP-A-2017-69133, when a terminal of a partner connector is inserted into the terminal housing portion, the terminal of the partner connector contacts the contact portion of the terminal of the electric connector, and the spring portion supporting the contact portion is elastically deformed in a short-side direction. Accordingly, elastic force (equivalent to contact pressure) is applied to the terminal of the partner connector. In this manner, the spring portion of the electric connector holds the terminal of the partner connector, and electric connection between the terminals of both these connectors is ensured.

### SUMMARY

An electric connector according to an embodiment of the present disclosure is an electric connector which includes a terminal; and a housing holding the terminal, in which the terminal has a first leg portion, a second leg portion, a third leg portion, a fourth leg portion, an extending portion, a first coupling portion, a second coupling portion, a third coupling portion, a mount portion, a fitting recessed portion, and a width changing portion, the first leg portion, the second leg portion, the third leg portion, and the fourth leg portion are provided apart from each other in an order of the first leg portion, the second leg portion, the third leg portion, and the fourth leg portion along a short-side direction of the electric connector, and each extend in a first fitting direction which is a fitting direction of fitting the electric connector in a partner connector, the extending portion is connected to an end portion of the first leg portion on a second fitting direction side which is opposite to a first fitting direction side, and extends in the short-side direction, the first coupling portion extends in the short-side direction, and connects an end portion of the first leg portion on the first fitting direction side and an end portion of the second leg portion on the first fitting direction side to each other, the second coupling portion extends in the short-side direction, and connects an end portion of the second leg portion on the second fitting direction side and an end portion of the third leg portion on the second fitting direction side to each other, the third coupling portion extends in the short-side direction, and connects an end portion of the third leg portion on the first fitting direction side and an end portion of the fourth leg portion on the first fitting direction side to each other, the mount portion is provided at an outer surface of the extending portion on the second fitting direction side, the housing is configured to fill a space surrounded by the first leg portion, the first coupling portion, and the second leg portion of the terminal and to fill a space surrounded by the third leg portion, the third coupling portion, and the fourth leg portion of the terminal, the fitting recessed portion is configured such that a terminal of the partner connector is receivable by a recessed portion formed by the second leg portion, the second coupling portion, and the third leg portion, the terminal is configured such that when the terminal of the partner connector is inserted into the recessed portion, the terminal of the partner connector contacts the second leg portion and the third leg portion, and accordingly, the first leg portion, the first coupling portion, the second leg portion, and the housing in the space surrounded by the first leg portion, the first coupling portion, and the second leg portion are integrally displaceable in the short-side direction and the third leg portion, the third coupling portion, the fourth leg portion, and the housing in the space surrounded by the third leg portion, the third coupling portion, and the fourth leg portion are integrally displaceable in the short-side direction, and the width changing portion is provided at least one of the second leg portion or the third leg portion so as to be exposed from the housing, and is configured such that a width of the terminal in a long-side direction of the electric connector changes at the width changing portion.

### BRIEF DESCRIPTION OF THE DRAWINGS

FIG. 1 is a perspective view of a connector assembly according to an embodiment of the present disclosure in a state before fitting;

FIG. 2 is a top view of a receptacle connector according to the embodiment of the present disclosure;

FIG. 3 is an exploded perspective view of the receptacle connector according to the embodiment of the present disclosure;

FIG. 4A is a perspective view of one terminal according to the embodiment of the present disclosure in a state of the one terminal being held by a housing, and FIG. 4B is a side view of the one terminal according to the embodiment of the present disclosure in a state of the one terminal being held by the housing;

FIG. 5 is a perspective view of the one terminal according to the embodiment of the present disclosure;

FIG. 6A is a perspective view of another terminal according to the embodiment of the present disclosure in a state of the another terminal being held by the housing, and FIG. 6B is a side view of the another terminal according to the embodiment of the present disclosure in a state of the another terminal being held by the housing;

FIG. 7 is a perspective view of the another terminal according to the embodiment of the present disclosure;

FIG. 8 is a side view of the connector assembly according to the embodiment of the present disclosure in the state before fitting.

FIG. 9 is a sectional view of the connector assembly according to the embodiment of the present disclosure as viewed along an IX-IX line in FIG. 8;

FIG. 10 is a partial perspective sectional view of the receptacle connector according to the embodiment of the present disclosure as viewed along the IX-IX line in FIG. 8;

FIG. 11 is a sectional view of the connector assembly according to the embodiment of the present disclosure as viewed along an XI-XI line in FIG. 8; and

FIG. 12 is a partial perspective sectional view of the receptacle connector according to the embodiment of the present disclosure as viewed along the XI-XI line in FIG. 8.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In recent years, electronic components have been mounted on a printed circuit board with a higher density due to, e.g., size reduction in electronic equipment such as a smartphone or a mobile phone and function enhancement thereof. Accordingly, size reduction in an electric connector itself has been demanded. With size reduction in the electric connector, a terminal and a housing have been extremely reduced in size.

When the electric connector described in JP-A-2017-69133 is reduced in size, the spring portion of the terminal is also extremely reduced in size (narrowed) with size reduction in the terminal. As a result, the elastic force of the spring portion of the terminal decreases, and it is difficult to apply sufficient contact pressure to the terminal of the partner connector. Thus, for example, when the electric connector is repeatedly detached and attached, electric connection between the terminals cannot be ensured in some cases.

The present disclosure has been made to solve the above-described problems, and one object thereof is to provide an electric connector capable of properly ensuring contact pressure to be applied to a partner connector.

An electric connector according to one embodiment of the present disclosure is an electric connector which includes a terminal; and a housing holding the terminal, in which the terminal has a first leg portion, a second leg portion, a third leg portion, a fourth leg portion, an extending portion, a first coupling portion, a second coupling portion, a third coupling portion, a mount portion, a fitting recessed portion, and a width changing portion, the first leg portion, the second leg portion, the third leg portion, and the fourth leg portion are provided apart from each other in an order of the first leg portion, the second leg portion, the third leg portion, and the fourth leg portion along a short-side direction of the electric connector, and each extend in a first fitting direction which is a fitting direction of fitting the electric connector in a partner connector, the extending portion is connected to an end portion of the first leg portion on a second fitting direction side which is opposite to a first fitting direction side, and extends in the short-side direction, the first coupling portion extends in the short-side direction, and connects an end portion of the first leg portion on the first fitting direction side and an end portion of the second leg portion on the first fitting direction side to each other, the second coupling portion extends in the short-side direction, and connects an end portion of the second leg portion on the second fitting direction side and an end portion of the third leg portion on the second fitting direction side to each other, the third coupling portion extends in the short-side direction, and connects an end portion of the third leg portion on the first fitting direction side and an end portion of the fourth leg portion on the first fitting direction side to each other, the mount portion is provided at an outer surface of the extending portion on the second fitting direction side, the housing is configured to fill a space surrounded by the first leg portion, the first coupling portion, and the second leg portion of the terminal and to fill a space surrounded by the third leg portion, the third coupling portion, and the fourth leg portion of the terminal, the fitting recessed portion is configured such that a terminal of the partner connector is receivable by a recessed portion formed by the second leg portion, the second coupling portion, and the third leg portion, the terminal is configured such that when the terminal of the partner connector is inserted into the recessed portion, the terminal of the partner connector contacts the second leg portion and the third leg portion, and accordingly, the first leg portion, the first coupling portion, the second leg portion, and the housing in the space surrounded by the first leg portion, the first coupling portion, and the second leg portion are integrally displaceable in the short-side direction and the third leg portion, the third coupling portion, the fourth leg portion, and the housing in the space surrounded by the third leg portion, the third coupling portion, and the fourth leg portion are integrally displaceable in the short-side direction, and the width changing portion is provided at least one of the second leg portion or the third leg portion so as to be exposed from the housing, and is configured such that a width of the terminal in a long-side direction of the electric connector changes at the width changing portion.

According to the electric connector of the present disclosure, the contact pressure to be applied to the partner connector can be properly ensured.

Hereinafter, an embodiment of the present disclosure will be described with reference to the drawings. Note that in all figures for describing the embodiment, the same reference numerals are basically used to represent the same members and repeated description thereof may be omitted.

### Configurations of Connector Assembly and Electric Connector

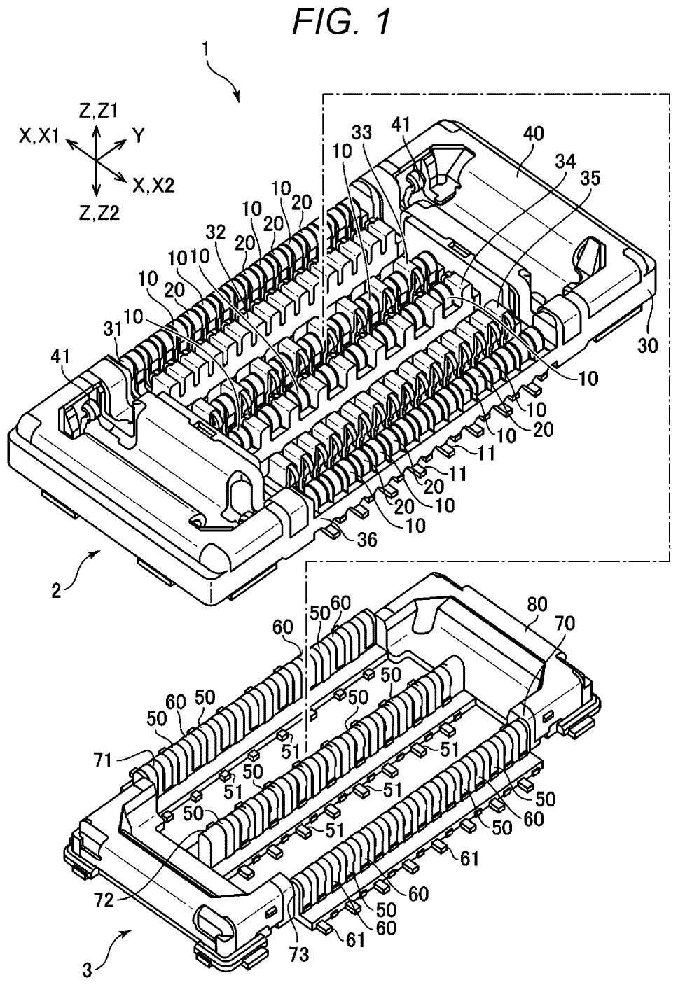

First, the configuration of a connector assembly according to the embodiment of the present disclosure will be described with reference to FIG. 1. FIG. 1 is a perspective view of the connector assembly according to the present embodiment in a non-fitting state.

As shown in FIG. 1, a connector assembly 1 according to the present embodiment has a receptacle connector 2 and a plug connector 3, and the receptacle connector 2 and the plug connector 3 are formed to be fitted in each other. Hereinafter, when the receptacle connector 2 and the plug connector 3 are not distinguished from each other, these connectors may be referred to as a “connector(s) 2, 3” or merely as a “connector(s)”. The connector 2, 3 is mounted on a board (not-shown) which is a mount target to be electrically connected, such as a printed circuit board. For both the receptacle connector 2 and the plug connector 3 in FIG. 1, a fitting side (fitting surface) is a front side, and a board mount side is a back side. Moreover, the connector 2, 3 can be used as an internal component in small electronic equipment such as a mobile phone, a smartphone, a digital camera, or a laptop computer. Note that the receptacle connector 2 is one example of an “electric connector” in the present disclosure. The receptacle connector 2 is also mountable on various mount targets, such as a flexible flat cable, other than the board such as the printed circuit board, but an example where the receptacle connector 2 is mounted on the board will be described below.

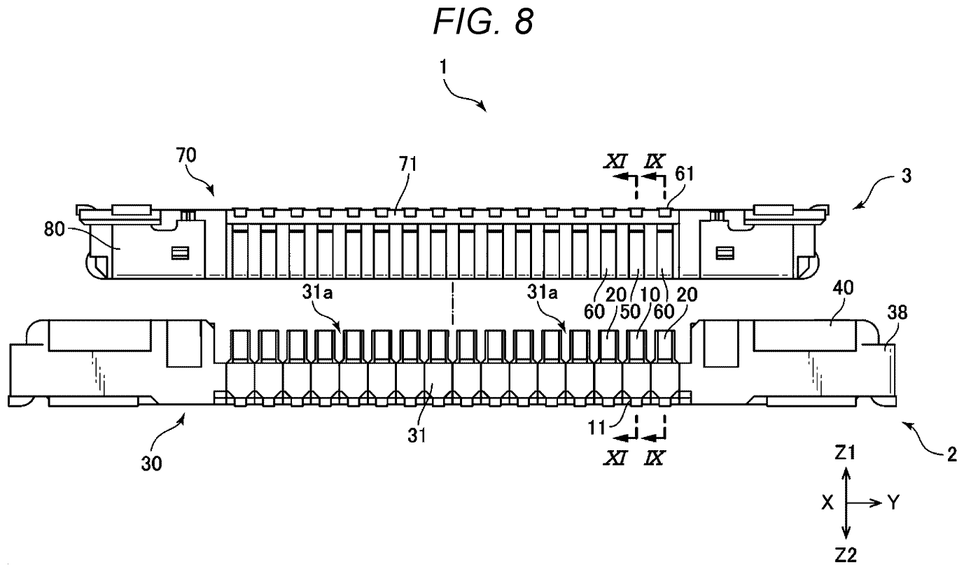

In FIG. 1 (the same also applied to other figures), the short-side direction (width direction) of the connector is shown as “X” (equivalent to a “lateral direction” in the present disclosure), the long-side direction (depth direction) of the connector is shown as “Y” (equivalent to a “longitudinal direction” in the present disclosure), and the fitting direction (upper-lower direction) of the connector is shown as “Z.” In other words, an axis along the short-side direction is defined as an X-axis, an axis along the long-side direction is defined as a Y-axis, and an axis along the fitting direction is defined as a Z-axis. Moreover, in the present specification, one direction in the short-side direction X will be referred to as a “first short-side direction X1,” and a direction opposite to the first short-side direction X1 in the short-side direction X will be referred to as a “second short-side direction X2.” Further, in the present specification, in the fitting direction Z, the side of a certain connector on which the certain connector receives a partner connector will be defined as “upper” or “front,” and the side on which the certain connector is attached to the board will be defined as “lower” or “back.” Specifically, for the receptacle connector 2, a direction (equivalent to a “first fitting direction” in the present disclosure) indicated by “Z1” in the fitting direction Z is equivalent to an “upper direction,” and a direction (equivalent to a “second fitting direction” in the present disclosure) indicated by “Z2” in the fitting direction Z is equivalent to a “lower direction.” On the other hand, FIG. 1 shows, for the sake of convenience in description, a state in which the plug connector 3 is upside down in order to fit the plug connector 3 in the receptacle connector 2, and therefore, the direction indicated by “Z2” is actually equivalent to the “upper direction” and the direction indicated by “Z1” is actually equivalent to the “lower direction” (i.e., when the plug connector 3 is in a state of being fittable in the receptacle connector 2) (also see FIGS. 8, 9, and 11).

As shown in FIG. 1, the receptacle connector 2 mainly has a plurality of terminals 10 and a plurality of terminals 20 as signal terminals, a reinforcing metal fitting 40, and a housing 30 holding the terminals 10, 20 and the reinforcing metal fitting 40. Although details will be described later, the terminals 10, 20 have similar shapes.

The housing 30 has long-side wall portions 31, 32, 33, 34, 35, 36, which extend in the long-side direction Y, in this order along the short-side direction X (particularly in this order in the second short-side direction X2). The long-side wall portions 31, 32 are coupled to each other, the long-side wall portion 31 is located on the first short-side direction X1 side, and the long-side wall portion 32 is located on the second short-side direction X2 side. The long-side wall portions 33, 34 are coupled to each other, the long-side wall portion 33 is located on the first short-side direction X1 side, and the long-side wall portion 34 is located on a second short-side direction X2 side. The long-side wall portions 35, 36 are coupled to each other, the long-side wall portion 35 is located on the first short-side direction X1 side, and the long-side wall portion 36 is located on the second short-side direction X2 side.

The coupled long-side wall portions 31, 32 and the coupled long-side wall portions 33, 34 are apart from each other in the short-side direction X. The coupled long-side wall portions 33, 34 and the coupled long-side wall portions 35, 36 are apart from each other in the short-side direction X. The long-side wall portions 33, 34 are located at the center of the receptacle connector 2 in the short-side direction X, and on the other hand, the long-side wall portions 31, 32 are located at a first short-side direction X1-side end portion of the receptacle connector 2 in the short-side direction X and the long-side wall portions 35, 36 are located at a second short-side direction X2-side end portion of the receptacle connector 2 in the short-side direction X.

The plurality of terminals 10, 20 arranged at equal intervals along the long-side direction Y is provided in the long-side wall portions 31, 32. The plurality of terminals 10 arranged at equal intervals along the long-side direction Y is provided in the long-side wall portions 33, 34. The plurality of terminals 10, 20 arranged at equal intervals along the long-side direction Y is provided in the long-side wall portions 35, 36.

In this case, the total number of the plurality of terminals 10, 20 provided in the long-side wall portions 31, 32, the total number of the plurality of terminals 10 provided in the long-side wall portions 33, 34, and the total number of the plurality of terminals 10, 20 provided in the long-side wall portions 35, 36 are equal to each other.

Particularly, the plurality of terminals 10, 20 provided in the long-side wall portions 31, 32, the plurality of terminals 10 provided in the long-side wall portions 33, 34, and the plurality of terminals 10, 20 provided in the long-side wall portions 35, 36 are arranged at the same positions corresponding to each other in the long-side direction Y. Further, the terminals 10 are continuously arranged along the long-side direction Y in the long-side wall portions 33, 34, and on the other hand, the terminals 10 and the terminals 20 are alternately arranged along the long-side direction Y in the long-side wall portions 31, 32 and the long-side wall portions 35, 36.

Note that the long-side wall portions 31, 32, the long-side wall portions 33, 34, and the long-side wall portions 35, 36 are equivalent to a “first wall portion,” a “second wall portion,” and a “third wall portion” in the present disclosure, respectively.

On the other hand, the plug connector 3 mainly has a plurality of terminals 50 and a plurality of terminals 60 as signal terminals, a reinforcing metal fitting 80, and a housing 70 holding the terminals 50, 60 and the reinforcing metal fitting 80. Although details will be described later, the terminals 50, 60 have similar shapes, and the terminal 50 is fitted in the terminal 10 and the terminal 60 is fitted in the terminal 20. The housing 70 has long-side wall portions 71, 72, 73 provided in this order along the short-side direction X, extending in the long-side direction Y, and provided apart from each other in the short-side direction X. The long-side wall portion 72 is located at the center of the plug connector 3 in the short-side direction X, and on the other hand, the long-side wall portions 71, 73 are located at the end portions of the plug connector 3 in the short-side direction X.

The plurality of terminals 50, 60 arranged at equal intervals along the long-side direction Y is provided in the long-side wall portion 71. The plurality of terminals 50 arranged at equal intervals along the long-side direction Y is provided in the long-side wall portion 72. The terminals 50, 60 arranged at equal intervals along the long-side direction Y are provided in the long-side wall portion 73.

In this case, the total number of the plurality of terminals 50, 60 provided in the long-side wall portion 71, the total number of the plurality of terminals 50 provided in the long-side wall portion 72, and the total number of the plurality of terminals 50, 60 provided in the long-side wall portion 73 are equal to each other.

Particularly, the plurality of terminals 50, 60 provided in the long-side wall portion 71, the plurality of terminals 50 provided in the long-side wall portion 72, and the plurality of terminals 50, 60 provided in the long-side wall portion 73 are arranged at the same positions corresponding to each other in the long-side direction Y. Moreover, the terminals 50 are continuously arranged along the long-side direction Y in the long-side wall portion 72, and on the other hand, the terminals 50 and the terminals 60 are alternately arranged along the long-side direction Y in the long-side wall portion 71 and the long-side wall portion 73.

Note that the receptacle connector 2 is produced by integral molding using a conductive member forming the terminals 10, 20 and the reinforcing metal fitting 40, such as copper alloy, and resin forming the housing 30, such as liquid crystal polymer (LCP). Typically, the terminals 10, 20 and the reinforcing metal fitting 40 are insert-molded with the housing 30. Moreover, the plug connector 3 is also produced by integral molding using a conductive member forming the terminals 50, 60 and the reinforcing metal fitting 80, such as copper alloy, and resin forming the housing 70, such as liquid crystal polymer (LCP). Typically, the terminals 50, 60 and the reinforcing metal fitting 80 are insert-molded with the housing 70.

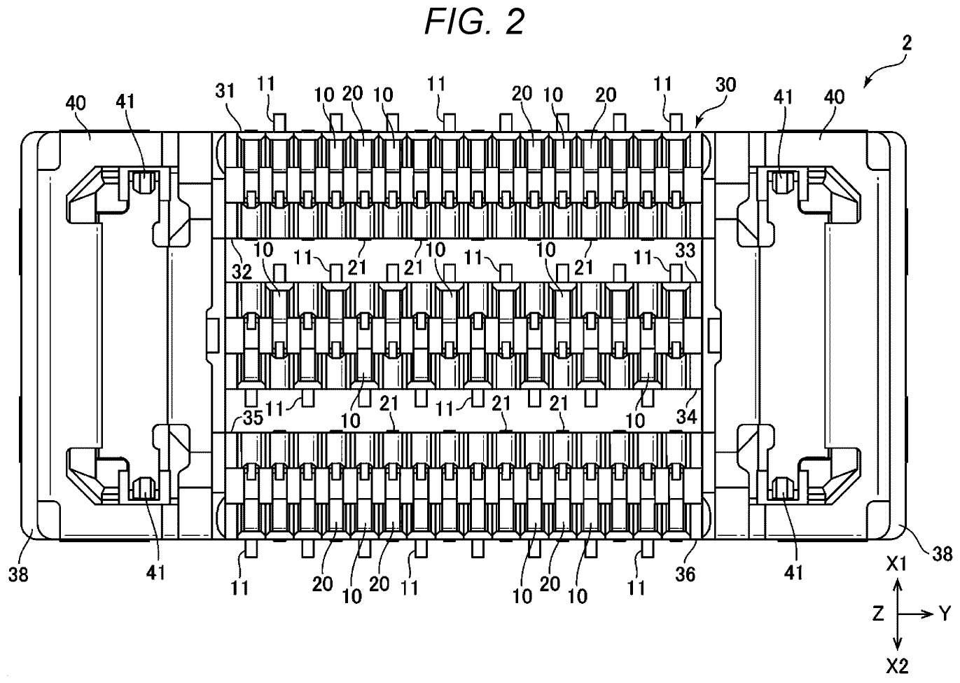

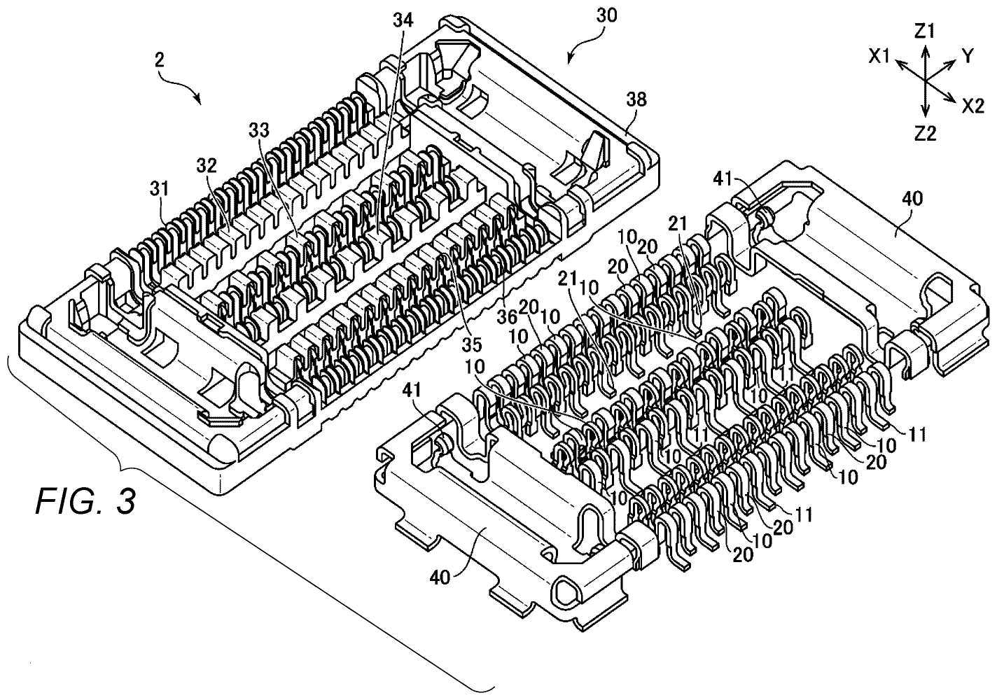

Next, the receptacle connector 2 according to the present embodiment will be specifically described with reference to FIGS. 2 and 3. FIG. 2 is a top view of the receptacle connector 2 according to the present embodiment as viewed from above, and FIG. 3 is an exploded perspective view of the receptacle connector 2 according to the present embodiment.

As shown in FIGS. 2 and 3, in the receptacle connector 2, the plurality of terminals 10, 20 is alternately provided in the long-side wall portions 31, 32 of the housing 30, the plurality of terminals 10 is continuously provided in the long-side wall portions 33, 34 of the housing 30, and the plurality of terminals 10, 20 is alternately provided in the long-side wall portions 35, 36 of the housing 30, as described above. These terminals 10, 20 are each mounted on the board at mount portions 11, 21 provided at end portions in the short-side direction X. The mount portion 11, 21 is a portion for connecting the terminal 10, 20 to the board by soldering.

Specifically, the plurality of terminals 10, 20 provided in the long-side wall portions 31, 32 is arranged such that the mount portions 11, 21 of the terminals 10, 20 adjacent to each other in the long-side direction Y are alternately located on the first short-side direction X1 side and the second short-side direction X2 side. In this case, each mount portion 11 of the plurality of terminals 10 is located on the first short-side direction X1 side (i.e., located so as to face outward of the receptacle connector 2), and each mount portion 21 of the plurality of terminals 20 is located on the second short-side direction X2 side (i.e., located so as to face the long-side wall portion 33, 34 side).

Moreover, the plurality of terminals 10 provided in the long-side wall portions 33, 34 is arranged such that the mount portions 11 of the terminals 10 adjacent to each other in the long-side direction Y are alternately located on the first short-side direction X1 side and the second short-side direction X2 side. In this case, the plurality of terminals 10 is arranged in the long-side wall portions 33, 34 such that the first short-side direction X1 side and second short-side direction X2 side of the terminals 10 adjacent to each other in the long-side direction Y are inverted (specifically, inverted with respect to the axis along the fitting direction Z).

Further, the plurality of terminals 10, 20 provided in the long-side wall portions 35, 36 is arranged such that the mount portions 11, 21 of the terminals 10, 20 adjacent to each other in the long-side direction Y are alternately located on the first short-side direction X1 side and the second short-side direction X2 side. In this case, each mount portion 11 of the plurality of terminals 10 is located on the second short-side direction X2 side (i.e., located so as to face outward of the receptacle connector 2), and each mount portion 21 of the plurality of terminals 20 is located on the first short-side direction X1 side (i.e., located so as to face the long-side wall portion 33, 34 side).

When the plurality of terminals 10, 20 provided in the long-side wall portions 31, 32, the plurality of terminals 10 provided in the long-side wall portions 33, 34, and the plurality of terminals 10, 20 provided in the long-side wall portions 35, 36 are cut along the XZ plane at a certain position in the long-side direction Y, three terminals 10, 20 arranged along the short-side direction X are visually recognized. In the section along the XZ plane, the terminal 10 (terminal 10 provided in the long-side wall portions 33, 34) at the center in the short-side direction X is sandwiched between both the terminal 10 and the terminal 20. That is, since the terminals 10 are continuously arranged along the long-side direction Y in the long-side wall portions 33, 34 and the terminals 10 and the terminals 20 are alternately arranged along the long-side direction Y in the long-side wall portions 31, 32 and the long-side wall portions 35, 36, the terminal 10, 20 arranged at the same position in the long-side direction Y in the long-side wall portions 35, 36 as that of the corresponding terminal 10, 20 in the long-side wall portions 31, 32 differs (i.e., the terminals 10, 20 are arranged alternately).

Here, a line including the plurality of terminals 10 provided in the long-side wall portions 31, 32 is taken as a first line, and a line including the plurality of terminals 20 provided in the long-side wall portions 31, 32 is taken as a second line. A line including the plurality of terminals 10 whose mount portions 11 are located on the first short-side direction X1 side among the plurality of terminals 10 provided in the long-side wall portions 33, 34 is taken as a third line, and a line including the plurality of terminals 10 whose mount portions 11 are located on the second short-side direction X2 side among the plurality of terminals 10 provided in the long-side wall portions 33, 34 is taken as a fourth line. A line including the plurality of terminals 20 provided in the long-side wall portions 35, 36 is taken as a fifth line, and a line including the plurality of terminals 10 provided in the long-side wall portions 35, 36 is taken as a sixth line. That is, the receptacle connector 2 has the plurality of terminals 10, 20 arranged in “six lines” in the short-side direction X.

The first line is a line in which the plurality of terminals 10 is arranged in the first wall portion along the long-side direction Y such that the mount portions 11 are located on the first short-side direction X1 side, and the second line is a line in which the plurality of terminals 20 is arranged in the first wall portion along the long-side direction Y such that the mount portions 21 are located on the second short-side direction X2 side. The third line is a line in which the plurality of terminals 10 is arranged in the second wall portion along the long-side direction Y such that the mount portions 11 are located on the first short-side direction X1 side, and the fourth line is a line in which the plurality of terminals 10 is arranged in the second wall portion along the long-side direction Y such that the mount portions 11 are located on the second short-side direction X2 side. The fifth line is a line in which the plurality of terminals 20 is arranged in the third wall portion along the long-side direction Y such that the mount portions 21 are located on the first short-side direction X1 side, and the sixth line is a line in which the plurality of terminals 10 is arranged in the third wall portion along the long-side direction Y such that the mount portions 11 are located on the second short-side direction X2 side.

The receptacle connector 2 may be configured as follows.

The plurality of terminals of the receptacle connector 2 may include terminals having mount portions on the first short-side direction X1 side and terminals having mount portions on the second short-side direction X2 side. The first to sixth lines may include a first line in which the plurality of terminals having the mount portions on the first short-side direction X1 side is provided in the first wall portion along the long-side direction Y, a second line in which the plurality of terminals having the mount portions on the second short-side direction X2 side is provided in the first wall portion along the long-side direction Y, a third line in which the plurality of terminals having the mount portions on the first short-side direction X1 side is provided in the second wall portion along the long-side direction Y, a fourth line in which the plurality of terminals having the mount portions on the second short-side direction X2 side is provided in the second wall portion along the long-side direction Y, a fifth line in which the plurality of terminals having the mount portions on the first short-side direction X1 side is provided in the third wall portion along the long-side direction Y, and a sixth line in which the plurality of terminals having the mount portions on the second short-side direction X2 side is provided in the third wall portion along the long-side direction Y. The plurality of terminals provided in each of the first wall portion, the second wall portion, and the third wall portion may be arranged such that the mount portions of the terminals adjacent to each other in the long-side direction Y are alternately located on the first short-side direction X1 side and the second short-side direction X2 side.

Further, as shown in FIGS. 2 and 3, the receptacle connector 2 has a pair of reinforcing metal fittings 40. The pair of reinforcing metal fittings 40 is provided at both ends of the receptacle connector 2 in the long-side direction Y, and extends in the short-side direction X. The pair of reinforcing metal fittings 40 is provided apart from each other with the terminals 10, 20 and the long-side wall portions 31 to 36 of the housing 30 interposed therebetween, and extends in the short-side direction X in the housing 30. The pair of reinforcing metal fittings 40 is held by a pair of short-side wall portions 38 provided so as to face each other in the long-side direction Y. Each of the pair of reinforcing metal fittings 40 has two terminals 41. The two terminals 41 are each provided in the vicinity of a first short-side direction X1-side end portion of the reinforcing metal fitting 40 and the vicinity of a second short-side direction X2-side end portion of the reinforcing metal fitting 40. These terminals 41 are used, for example, as power terminals.

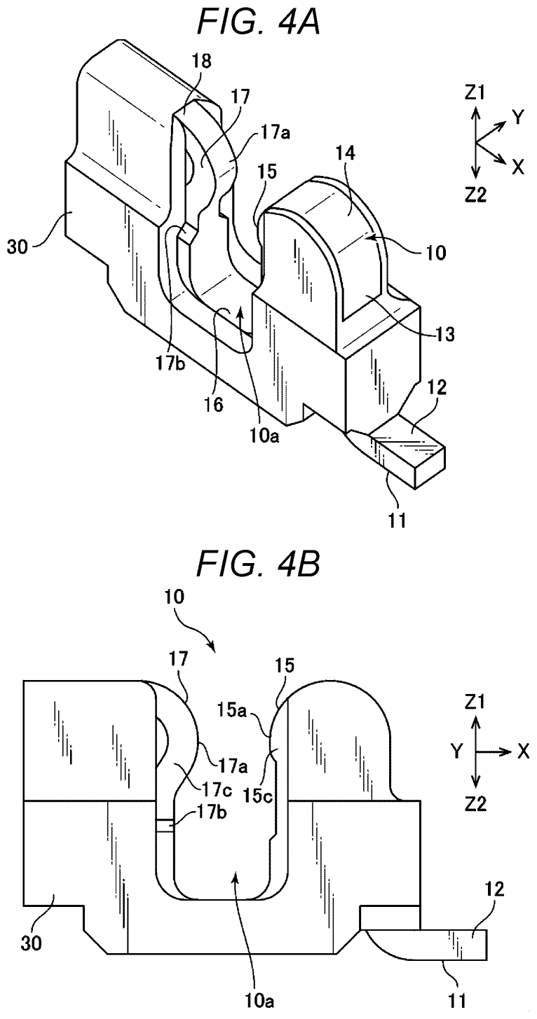

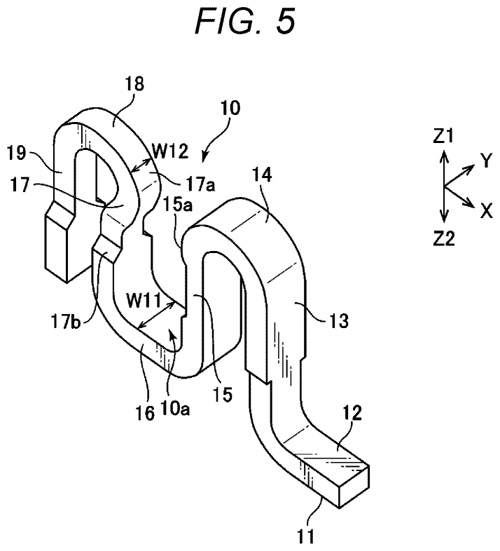

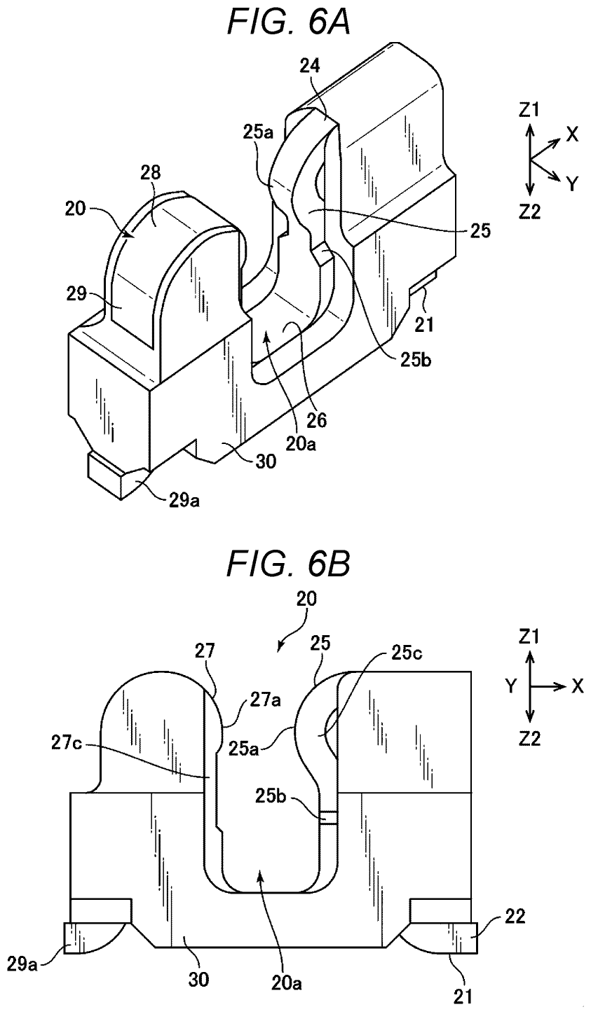

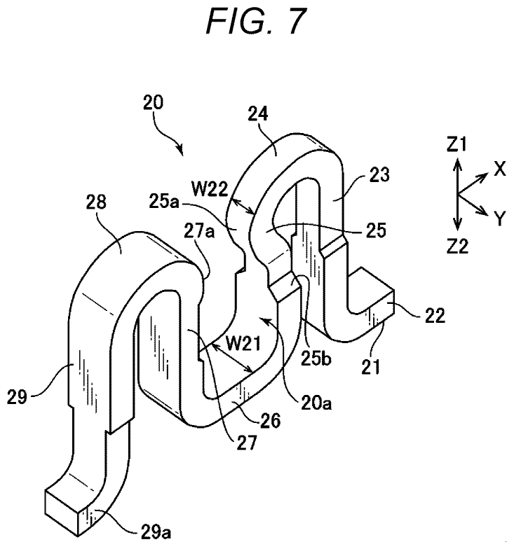

Next, the terminals 10, 20 of the receptacle connector 2 according to the present embodiment will be specifically described with reference to FIGS. 4A to 7. FIG. 4A is a perspective view of the terminal 10 held by the housing 30, and FIG. 4B is a side view of the terminal 10 held by the housing 30 as viewed along the long-side direction Y. FIG. 5 is a perspective view of only the terminal 10. FIG. 6A is a perspective view of the terminal 20 held by the housing 30, and FIG. 6B is a side view of the terminal 20 held by the housing 30 as viewed along the long-side direction Y. FIG. 7 is a perspective view of only the terminal 20.

Note that FIGS. 4A, 4B, 6A, and 6B show only part of the housing 30 surrounding one terminal 10, 20. Particularly, the housing 30 shown in FIGS. 4A, 4B, 6A, and 6B is equivalent to part of the long-side wall portions 31, 32, the long-side wall portions 33, 34, and the long-side wall portions 35, 36 described above. As described above (see FIGS. 1 and 2), the terminal 10 is provided in each of the long-side wall portions 31, 32, the long-side wall portions 33, 34, and the long-side wall portions 35, 36, and the terminal 20 is provided in each of the long-side wall portions 31, 32 and the long-side wall portions 35, 36.

As shown in FIGS. 4A, 4B, and 5 (particularly FIG. 5), the terminal 10 has a first leg portion 13, a second leg portion 15, a third leg portion 17, a fourth leg portion 19, an extending portion 12, a first coupling portion 14, a second coupling portion 16, and a third coupling portion 18.

The first leg portion 13, the second leg portion 15, the third leg portion 17, and the fourth leg portion 19 extend in the fitting direction Z, and in this order, are provided apart from each other along the short-side direction X. The extending portion 12 is connected to a lower direction Z2-side end portion of the first leg portion 13, and extends in the short-side direction X.

The first coupling portion 14 extends in the short-side direction X, and connects an upper direction Z1-side end portion of the first leg portion 13 and an upper direction Z1-side end portion of the second leg portion 15 to each other. The second coupling portion 16 extends in the short-side direction X, and connects a lower direction Z2-side end portion of the second leg portion 15 and a lower direction Z2-side end portion of the third leg portion 17 to each other. The third coupling portion 18 extends in the short-side direction X, and connects an upper direction Z1-side end portion of the third leg portion 17 and an upper direction Z1-side end portion of the fourth leg portion 19 to each other.

The first leg portion 13, the first coupling portion 14, and the second leg portion 15 coupled to each other form a substantially inverted U-shape, and the third leg portion 17, the third coupling portion 18, and the fourth leg portion 19 coupled to each other form a substantially inverted U-shape. The first leg portion 13, the second leg portion 15, the third leg portion 17, and the fourth leg portion 19 include not only portions extending straight along the fitting direction Z, but also portions (i.e., curved portions) extending at an angle with respect to the fitting direction Z. Moreover, the terminal 10 has, at the lower direction Z2-side outer surface (bottom surface) of the extending portion 12, the mount portion 11 to be mounted on the board.

The terminal 10 further has a fitting recessed portion 10a formed by the second leg portion 15, the second coupling portion 16, and the third leg portion 17. The fitting recessed portion 10a is configured such that the terminal 50 (not shown) of the plug connector 3 is receivable by a recessed portion formed by the second leg portion 15, the second coupling portion 16, and the third leg portion 17. When the terminal 50 of the plug connector 3 is inserted into the fitting recessed portion 10a, the terminal 50 contacts the second leg portion 15 and the third leg portion 17. Accordingly, the first leg portion 13, the first coupling portion 14, and the second leg portion 15 forming the substantially inverted U-shape are integrally displaced in the short-side direction X, and the third leg portion 17, the third coupling portion 18, and the fourth leg portion 19 forming the substantially inverted U-shape are integrally displaced in the short-side direction X. In this case, the second leg portion 15 contacts the terminal 50 at a contact point 15a on an outer wall surface facing the fitting recessed portion 10a, and the third leg portion 17 contacts the terminal 50 at a contact point 17a on an outer wall surface facing the fitting recessed portion 10a.

Specifically, the contact point 15a is located at a curved portion of the second leg portion 15 protruding to the fitting recessed portion 10a side. The contact point 17a is located at a curved portion of the third leg portion 17 protruding to the fitting recessed portion 10a side. More specifically, the curved portion of the third leg portion 17 including the contact point 17a more protrudes to the fitting recessed portion 10a side than the curved portion of the second leg portion 15 including the contact point 15a. That is, the amount of protrusion of the curved portion of the third leg portion 17 to the fitting recessed portion 10a side is greater than the amount of protrusion of the curved portion of the second leg portion 15 to the fitting recessed portion 10a side. Thus, the contact point 17a tends to have a greater amount of contact (interference amount) with the terminal 50 than that of the contact point 15a, and therefore, the contact point 17a of the third leg portion 17 serves as a main contact point with the terminal 50 and the contact point 15a of the second leg portion 15 serves as a sub contact point with the terminal 50.

The terminal 10 further has, at the third leg portion 17, a width changing portion 17b at which the width of the terminal 10 in the long-side direction Y changes. The width changing portion 17b is exposed from the housing 30 (FIGS. 4A and 4B). The width changing portion 17b is configured such that the width of the terminal 10 in the long-side direction Y changes at the width changing portion 17b. In the present embodiment, the width of the terminal 10 in the long-side direction Y changes from W11 to W12 and vice versa (W11>W12) at the width changing portion 17b (FIG. 5).

Further, each of the second leg portion 15 and the third leg portion 17 is configured such that portions 15c, 17c of a pair of side surfaces facing each other in the long-side direction Y are exposed from the housing 30 (FIG. 4B). The width changing portion 17b of the terminal 10 and the portions 15c, 17c of the side surfaces of the second leg portion 15 and the third leg portion 17, which are exposed from the housing 30, are used for holding the terminal 10 with a die when the receptacle connector 2 is insert-molded. Specifically, the width changing portion 17b is used for pressing the die against the terminal 10 in the fitting direction Z, and the portions 15c, 17c of the side surfaces of the second leg portion 15 and the third leg portion 17 are used for pressing the die against the terminal 10 in the long-side direction Y.

Next, as shown in FIGS. 6A, 6B, and 7 (particularly FIG. 7), the terminal 20 has a first leg portion 23, a second leg portion 25, a third leg portion 27, a fourth leg portion 29, an extending portion 22, a first coupling portion 24, a second coupling portion 26, a third coupling portion 28, and an extending portion 29a.

The first leg portion 23, the second leg portion 25, the third leg portion 27, and the fourth leg portion 29 extend in the fitting direction Z, and in this order, are provided apart from each other along the short-side direction X. The extending portion 22 is connected to a lower direction Z2-side end portion of the first leg portion 23, and extends in the short-side direction X.

The first coupling portion 24 extends in the short-side direction X, and connects an upper direction Z1-side end portion of the first leg portion 23 and an upper direction Z1-side end portion of the second leg portion 25 to each other. The second coupling portion 26 extends in the short-side direction X, and connects a lower direction Z2-side end portion of the second leg portion 25 and a lower direction Z2-side end portion of the third leg portion 27 to each other. The third coupling portion 28 extends in the short-side direction X, and connects an upper direction Z1-side end portion of the third leg portion 27 and an upper direction Z1-side end portion of the fourth leg portion 29 to each other. The extending portion 29a is connected to a lower direction Z2-side end portion of the fourth leg portion 29, and extends in the short-side direction X.

The terminal 20 is different from the terminal 10 in that the extending portion 29a is provided. The first leg portion 23, the first coupling portion 24, and the second leg portion 25 coupled to each other form a substantially inverted U-shape. The third leg portion 27, the third coupling portion 28, and the fourth leg portion 29 coupled to each other form a substantially inverted U-shape. The first leg portion 23, the second leg portion 25, the third leg portion 27, and the fourth leg portion 29 include not only portions extending straight along the fitting direction Z, but also portions (i.e., curved portions) extending at an angle with respect to the fitting direction Z. Moreover, the terminal 20 has, at a lower direction Z2-side outer surface (bottom surface) of the extending portion 22, the mount portion 21 to be mounted on the board.

The terminal 20 further has a fitting recessed portion 20a formed by the second leg portion 25, the second coupling portion 26, and the third leg portion 27. The fitting recessed portion 20a is configured such that the terminal 60 (not shown) of the plug connector 3 is receivable by a recessed portion formed by the second leg portion 25, the second coupling portion 26, and the third leg portion 27. When the terminal 60 is inserted into the fitting recessed portion 20a, the terminal 60 contacts the second leg portion 25 and the third leg portion 27. Accordingly, the first leg portion 23, the first coupling portion 24, and the second leg portion 25 forming the substantially inverted U-shape are integrally displaced in the short-side direction X, and the third leg portion 27, the third coupling portion 28, and the fourth leg portion 29 forming the substantially inverted U-shape are integrally displaced in the short-side direction X. In this case, the second leg portion 25 contacts the terminal 60 at a contact point 25a on an outer wall surface facing the fitting recessed portion 20a, and the third leg portion 27 contacts the terminal 60 at a contact point 27a on an outer wall surface facing the fitting recessed portion 20a.

Specifically, the contact point 25a is located at a curved portion of the second leg portion 25 protruding to the fitting recessed portion 20a side. The contact point 27a is located at a curved portion of the third leg portion 27 protruding to the fitting recessed portion 20a side. More specifically, the curved portion of the second leg portion 25 including the contact point 25a more protrudes to the fitting recessed portion 20a side than the curved portion of the third leg portion 27 including the contact point 27a. That is, the amount of protrusion of the curved portion of the second leg portion 25 to the fitting recessed portion 20a side is greater than the amount of protrusion of the curved portion of the third leg portion 27 to the fitting recessed portion 20a side. Thus, the contact point 25a tends to have a greater amount of contact (interference amount) with the terminal 60 than that of the contact point 27a, and therefore, the contact point 25a of the second leg portion 25 serves as a main contact point with the terminal 60 and the contact point 27a of the third leg portion 27 serves as a sub contact point with the terminal 60. Since the terminal 10 is configured such that not the contact point 15a of the second leg portion 15 but the contact point 17a of the third leg portion 17 serves as the main contact point, the terminal 20 is also different from the terminal 10 in this point. Particularly, the terminal 10 is configured such that the third leg portion 17 farther from the mount portion 11 out of the second leg portion 15 and the third leg portion 17 has the main contact point, whereas the terminal 20 is configured such that the second leg portion 25 closer to the mount portion 21 out of the second leg portion 25 and the third leg portion 27 has the main contact point.

The terminal 20 further has, at the second leg portion 25, a width changing portion 25b at which the width of the terminal 20 in the long-side direction Y changes. The width changing portion 25b is exposed from the housing 30 (FIGS. 6A and 6B). The width changing portion 25b is configured such that the width of the terminal 20 in the long-side direction Y changes at the width changing portion 25b. In the present embodiment, the width of the terminal 20 in the long-side direction Y changes from W21 to W22 and vice versa (W21>W22) at the width changing portion 25b (FIG. 7). Since the terminal 10 has the width changing portion 17b not at the second leg portion 15 but at the third leg portion 17, the terminal 20 is also different from the terminal 10 in this point.

Further, each of the second leg portion 25 and the third leg portion 27 is configured such that portions 25c, 27c of a pair of side surfaces facing each other in the long-side direction Y are exposed from the housing 30 (FIG. 6B). The width changing portion 25b of the terminal 20 and the portions 25c, 27c of the side surfaces of the second leg portion 25 and the third leg portion 27, which are exposed from the housing 30, are used for holding the terminal 20 with the die when the receptacle connector 2 is insert-molded. Specifically, the width changing portion 25b is used for pressing the die against the terminal 20 in the fitting direction Z, and the portions 25c, 27c of the side surfaces of the second leg portion 25 and the third leg portion 27 are used for pressing the die against the terminal 20 in the long-side direction Y.

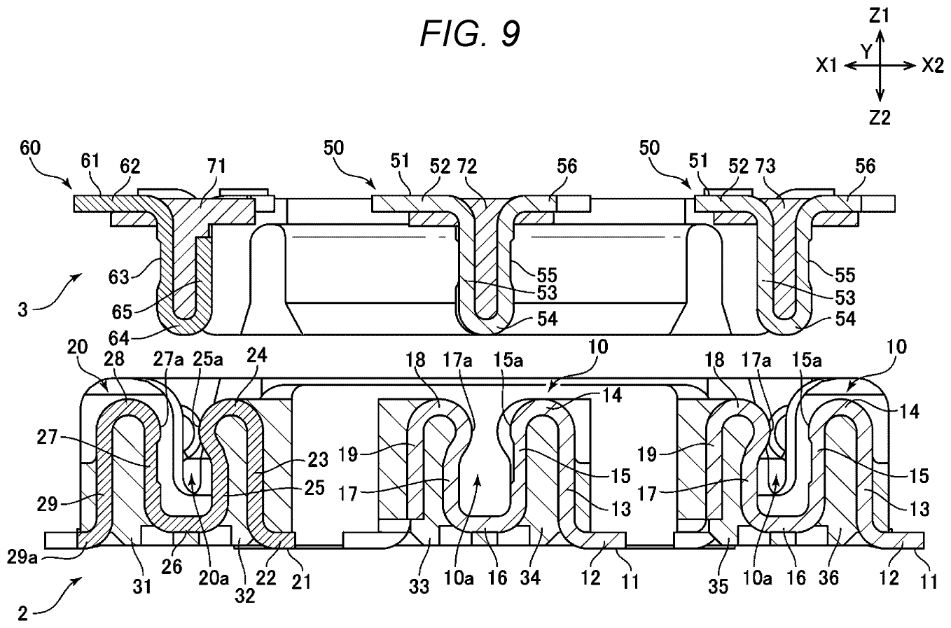

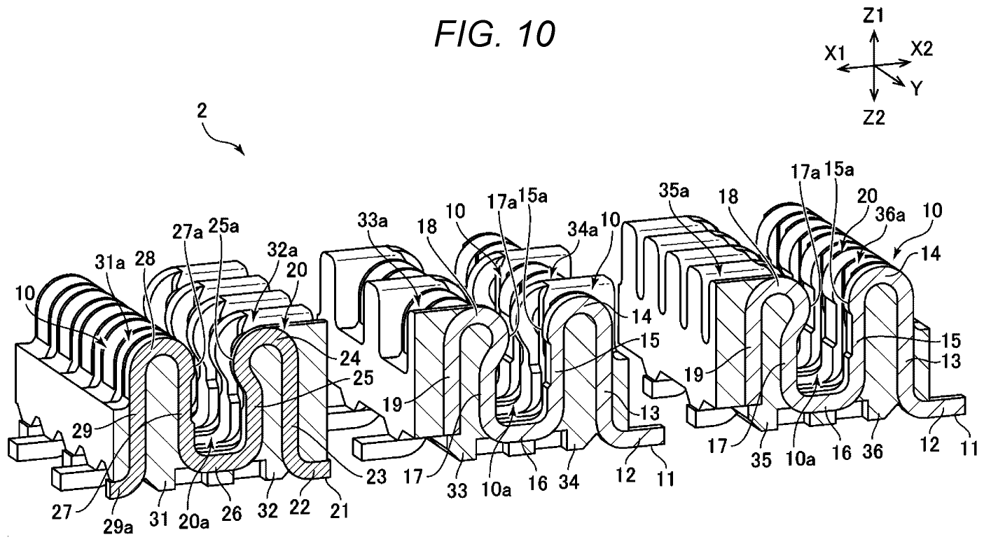

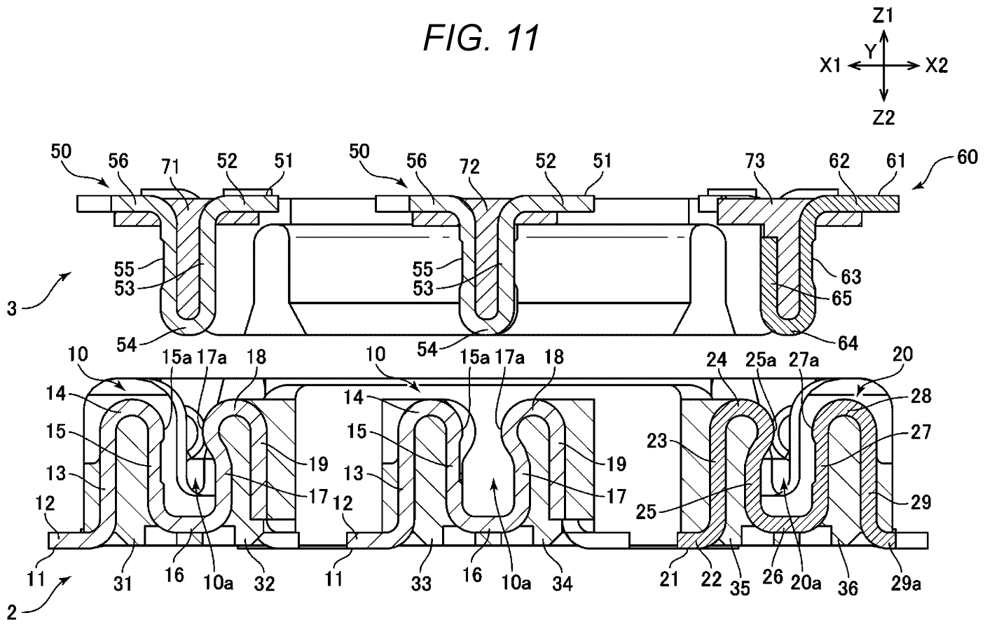

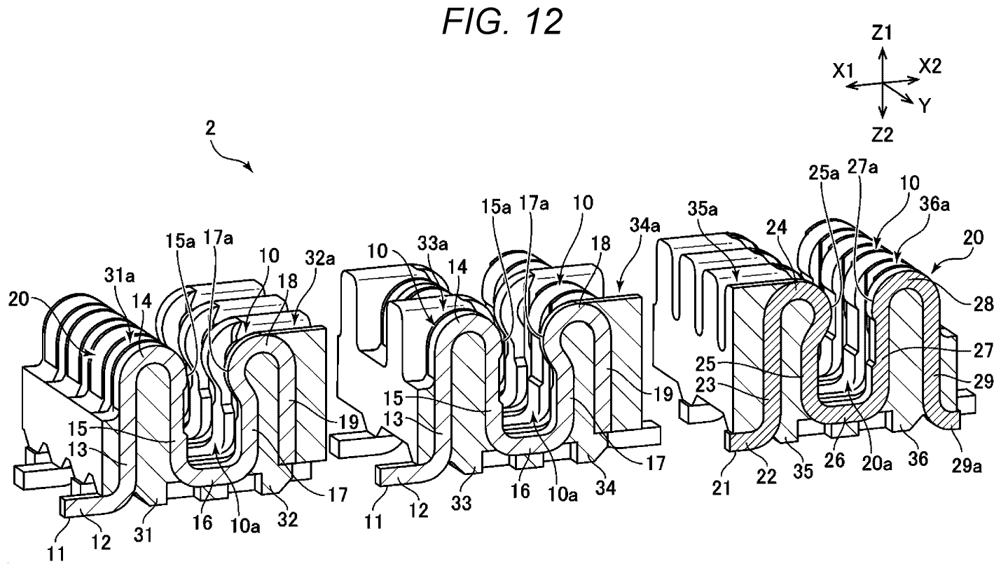

Next, e.g., specific sectional structures of the receptacle connector 2 and the plug connector 3 according to the present embodiment will be described with reference to FIGS. 8 to 12. FIG. 8 is a side view of the connector assembly 1 according to the present embodiment in a state before fitting as viewed along the short-side direction X (particularly, second short-side direction X2). FIG. 9 is a sectional view of the connector assembly 1 according to the present embodiment as viewed along an IX-IX line in FIG. 8, and FIG. 10 is a perspective sectional view of part of the receptacle connector 2 according to the present embodiment as viewed along the IX-IX line in FIG. 8. FIG. 11 is a sectional view of the connector assembly 1 according to the present embodiment as viewed along an XI-XI line in FIG. 8, and FIG. 12 is a perspective sectional view of part of the receptacle connector 2 according to the present embodiment as viewed along the XI-XI line in FIG. 8. Note that each of the IX-IX line and the XI-XI line in FIG. 8 is a cut line positioned so as to cut a group of the terminal 10, the terminal 20, the terminal 50, and the terminal 60 adjacent to each other in the short-side direction X in the connector 2, 3.

The configurations of the terminals 10, 20 other than those described with reference to FIGS. 4A to 7 will be described. As shown in FIGS. 9 to 12, in the terminal 10, a space surrounded by the first leg portion 13, the first coupling portion 14, and the second leg portion 15 is filled with resin (housing 30), and a space surrounded by the third leg portion 17, the third coupling portion 18, and the fourth leg portion 19 is filled with resin. Moreover, in the terminal 20, a space surrounded by the first leg portion 23, the first coupling portion 24, and the second leg portion 25 is filled with resin, and a space surrounded by the third leg portion 27, the third coupling portion 28, and the fourth leg portion 29 is filled with resin. Note that the above-described spaces in the terminals 10, 20 are filled with resin, for example, by insert molding.

In the terminal 10, when the terminal 50 is inserted into the fitting recessed portion 10a, the first leg portion 13, the first coupling portion 14, the second leg portion 15, and the resin in the space surrounded thereby are integrally displaced in the short-side direction X, and the third leg portion 17, the third coupling portion 18, the fourth leg portion 19, and the resin in the space surrounded thereby are integrally displaced in the short-side direction X.

Moreover, in the terminal 20, when the terminal 60 is inserted into the fitting recessed portion 20a, the first leg portion 23, the first coupling portion 24, the second leg portion 25, and the resin in the space surrounded thereby are integrally displaced in the short-side direction X, and the third leg portion 27, the third coupling portion 28, the fourth leg portion 29, and the resin in the space surrounded thereby are integrally displaced in the short-side direction X.

More specifically, in the terminal 20 provided in the long-side wall portions 31, 32 as shown in FIG. 9, the space surrounded by the first leg portion 23, the first coupling portion 24, and the second leg portion 25 is filled with the resin of the long-side wall portion 32, and the space surrounded by the third leg portion 27, the third coupling portion 28, and the fourth leg portion 29 is filled with the resin of the long-side wall portion 31. Moreover, in the terminal 10 provided in the long-side wall portions 31, 32 as shown in FIG. 11, the space surrounded by the first leg portion 13, the first coupling portion 14, and the second leg portion 15 is filled with the resin of the long-side wall portion 31, and the space surrounded by the third leg portion 17, the third coupling portion 18, and the fourth leg portion 19 is filled with the resin of the long-side wall portion 32.

In the terminal 10 provided in the long-side wall portions 33, 34 as shown in FIG. 9, the space surrounded by the first leg portion 13, the first coupling portion 14, and the second leg portion 15 is filled with the resin of the long-side wall portion 34, and the space surrounded by the third leg portion 17, the third coupling portion 18, and the fourth leg portion 19 is filled with the resin of the long-side wall portion 33. Moreover, in the terminal 10 (one inverted, i.e., horizontally inverted, from the terminal 10 provided in the long-side wall portions 33, 34 as shown in FIG. 9 with respect to the axis corresponding to the fitting direction Z) provided in the long-side wall portions 33, 34 as shown in FIG. 11, the space surrounded by the first leg portion 13, the first coupling portion 14, and the second leg portion 15 is filled with the resin of the long-side wall portion 33, and the space surrounded by the third leg portion 17, the third coupling portion 18, and the fourth leg portion 19 is filled with the resin of the long-side wall portion 34.

In the terminal 10 provided in the long-side wall portions 35, 36 as shown in FIG. 9, the space surrounded by the first leg portion 13, the first coupling portion 14, and the second leg portion 15 is filled with the resin of the long-side wall portion 36, and the space surrounded by the third leg portion 17, the third coupling portion 18, and the fourth leg portion 19 is filled with the resin of the long-side wall portion 35. Moreover, in the terminal 20 provided in the long-side wall portions 35, 36 as shown in FIG. 11, the space surrounded by the first leg portion 23, the first coupling portion 24, and the second leg portion 25 is filled with the resin of the long-side wall portion 35, and the space surrounded by the third leg portion 27, the third coupling portion 28, and the fourth leg portion 29 is filled with the resin of the long-side wall portion 36.

As shown in FIGS. 10 and 12, in the long-side wall portion 31, a slit 31a extending in the fitting direction Z and the short-side direction X is formed between each adjacent ones of the plurality of terminals 10, 20 arranged along the long-side direction Y (also see FIG. 8). In the long-side wall portion 32, a slit 32a extending in the fitting direction Z and the short-side direction X is formed between each adjacent ones of the plurality of terminals 10, 20 arranged along the long-side direction Y. Similarly, in the long-side wall portions 33, 34, a slit 33a, 34a extending in the fitting direction Z and the short-side direction X is formed between each adjacent ones of the plurality of terminals 10. Moreover, in the long-side wall portions 35, 36, a slit 35a, 36a extending in the fitting direction Z and the short-side direction X is formed between each adjacent ones of the plurality of terminals 10, 20.

Next, the terminals 50, 60 of the plug connector 3 will be described. As shown in FIGS. 9 and 11, the terminal 50 has a first leg portion 53, a second leg portion 55, an extending portion 52, a coupling portion 54, and an extending portion 56.

The first leg portion 53 and the second leg portion 55 extend in the fitting direction Z, and are provided apart from each other along the short-side direction X. The extending portion 52 is connected to a lower direction Z1-side end portion of the first leg portion 53, extends in the short-side direction X, and includes a mount portion 51. The coupling portion 54 extends in the short-side direction X, and connects an upper direction Z2-side end portion of the first leg portion 53 and an upper direction Z2-side end portion of the second leg portion 55 to each other. The extending portion 56 is connected to a lower direction Z1-side end portion of the second leg portion 55, and extends in the short-side direction X.

The terminal 60 has a first leg portion 63, a second leg portion 65, an extending portion 62, and a coupling portion 64.

The first leg portion 63 and the second leg portion 65 extend in the fitting direction Z, and are provided apart from each other along the short-side direction X. The extending portion 62 is connected to a lower direction Z1-side end portion of the first leg portion 63, extends in the short-side direction X, and includes a mount portion 61. The coupling portion 64 extends in the short-side direction X, and connects an upper direction Z2-side end portion of the first leg portion 63 and an upper direction Z2-side end portion of the second leg portion 65 to each other.

In the terminal 50, a space surrounded by the first leg portion 53, the coupling portion 54, and the second leg portion 55 coupled to each other is filled with the resin of the housing 70, and the first leg portion 53, the coupling portion 54, and the second leg portion 55 form a substantially U-shape. Such a substantially U-shaped portion is inserted into the fitting recessed portion 10a of the terminal 10 of the receptacle connector 2. In addition, in the terminal 60, a space surrounded by the first leg portion 63, the coupling portion 64, and the second leg portion 65 coupled to each other is filled with the resin of the housing 70, and the first leg portion 63, the coupling portion 64, and the second leg portion 65 form a substantially U-shape. Such a substantially U-shaped portion is inserted into the fitting recessed portion 20a of the terminal 20 of the receptacle connector 2.

Next, the arrangement of the terminals 10, 20 in the receptacle connector 2 will be described. In comparison between FIGS. 9 and 11 (also see FIG. 2), the plurality of terminals 10, 20 provided in the long-side wall portions 31, 32 is arranged such that the mount portions 11, 21 of the terminals 10, 20 adjacent to each other in the long-side direction Y are alternately located on the first short-side direction X1 side and the second short-side direction X2 side. Moreover, the plurality of terminals 10 provided in the long-side wall portions 33, 34 is arranged such that the mount portions 11 of the terminals 10 adjacent to each other in the long-side direction Y are alternately located on the first short-side direction X1 side and the second short-side direction X2 side (in this case, the adjacent terminals 10 are inverted, i.e., horizontally inverted, from each other with respect to the axis corresponding to the fitting direction Z). Further, the plurality of terminals 10, 20 provided in the long-side wall portions 35, 36 is arranged such that the mount portions 11, 21 of the terminals 10, 20 adjacent to each other in the long-side direction Y are alternately located on the first short-side direction X1 side and the second short-side direction X2 side.

As shown in FIGS. 9 and 11, when the terminals 10, 20 provided in the long-side wall portions 31, 32, the terminals 10 provided in the long-side wall portions 33, 34, and the terminals 10, 20 provided in the long-side wall portions 35, 36 are cut along the XZ plane at a certain position in the long-side direction Y, three terminals 10, 20 arranged along the short-side direction X are visually recognized. In the section along the XZ plane, the terminal 10 (terminal 10 provided in the long-side wall portions 33, 34) at the center in the short-side direction X is not sandwiched between only the terminals 10 or only the terminals 20, but is sandwiched between both the terminal 10 and the terminal 20. This is because the terminal 10, 20 arranged at the same position in the long-side direction Y in the long-side wall portions 35, 36 as that of the corresponding terminal 10, 20 in the long-side wall portions 31, 32 differs.

Further, as clearly shown in FIGS. 9 and 11, the mount portion 11 and the mount portion 21 are located on the identical side in the short-side direction X among the above-described three terminals 10, 20 arranged along the short-side direction X. In FIG. 9, two mount portions 11 of the terminals 10 and one mount portion 21 of the terminal 20 are all located on the second short-side direction X2 side in the terminals 10, 20. In FIG. 11, two mount portions 11 of the terminals 10 and one mount portion 21 of the terminal 20 are all located on the first short-side direction X1 side in the terminals 10, 20. Note that similarly in the terminals 50, 60 of the plug connector 3, all the mount portions 51, 61 are located on the identical side in the short-side direction X in the three terminals 50, 60 arranged along the short-side direction X.

As shown in FIGS. 9 and 11, in the plurality of terminals 10, 20 alternately provided in the long-side wall portions 31, 32, the contact point 17a of the third leg portion 17 as the main contact point of the terminal 10 and the contact point 25a of the second leg portion 25 as the main contact point of the terminal 20 are located on the identical side in the short-side direction X, specifically on the second short-side direction X2 side (see the contact point 17a of the terminal 10 at the left end in FIG. 11 and the contact point 25a of the terminal 20 at the left end in FIG. 9).

Similarly, in the plurality of terminals 10, 20 alternately provided in the long-side wall portions 35, 36, the contact point 17a of the third leg portion 17 as the main contact point of the terminal 10 and the contact point 25a of the second leg portion 25 as the main contact point of the terminal 20 are located on the identical side in the short-side direction X, specifically on the first short-side direction X1 side (see the contact point 17a of the terminal 10 at the right end in FIG. 9 and the contact point 25a of the terminal 20 at the right end in FIG. 11).

On the other hand, in the plurality of terminals 10 continuously provided in the long-side wall portions 33, 34, the contact points 17a of the third leg portions 17 as the main contact points are alternately located on the first short-side direction X1 side and the second short-side direction X2 side in the terminals 10 adjacent to each other in the long-side direction Y. Specifically, in FIG. 9, the contact point 17a is located on the first short-side direction X1 side in the terminal 10, and in FIG. 11, is located on the second short-side direction X2 side in the terminal 10. This is because adjacent ones of the plurality of terminals 10 provided in the long-side wall portions 33, 34 are inverted, i.e., horizontally inverted, from each other with respect to the axis corresponding to the fitting direction Z.

### Features and Effects

Next, features and effects of the receptacle connector 2 according to the above-described embodiment will be described.

In the receptacle connector 2 according to the present embodiment, the terminal 10 has the first leg portion 13, the second leg portion 15, the third leg portion 17, and the fourth leg portion 19 extending in the direction Z of fitting the receptacle connector 2 in the plug connector 3 and provided apart from each other in this order along the short-side direction X, the extending portion 12 connected to the lower direction Z2-side end portion of the first leg portion 13 and extending in the short-side direction X, the first coupling portion 14 extending in the short-side direction X and connecting the upper direction Z1-side end portion of the first leg portion 13 and the upper direction Z1-side end portion of the second leg portion 15 to each other, the second coupling portion 16 extending in the short-side direction X and connecting the lower direction Z2-side end portion of the second leg portion 15 and the lower direction Z2-side end portion of the third leg portion 17 to each other, and the third coupling portion 18 extending in the short-side direction X and connecting the upper direction Z1-side end portion of the third leg portion 17 and the upper direction Z1-side end portion of the fourth leg portion 19 to each other. The terminal 10 has, at the lower direction Z2-side outer surface of the extending portion 12, the mount portion 11 to be mounted on the board. The housing 30 fills the space surrounded by the first leg portion 13, the first coupling portion 14, and the second leg portion 15 and the space surrounded by the third leg portion 17, the third coupling portion 18, and the fourth leg portion 19. The terminal 10 has the fitting recessed portion 10a configured such that the terminal 50 of the plug connector 3 is received by the recessed portion formed by the second leg portion 15, the second coupling portion 16, and the third leg portion 17. The terminal 10 is configured such that when the terminal 50 of the plug connector 3 is inserted into the fitting recessed portion 10a, i.e., when the fitting recessed portion 10a receives the terminal 50 of the plug connector 3, the terminal 50 contacts the second leg portion 15 and the third leg portion 17 and accordingly the first leg portion 13, the first coupling portion 14, the second leg portion 15, and the housing 30 in the space surrounded thereby are integrally displaceable in the short-side direction X and the third leg portion 17, the third coupling portion 18, the fourth leg portion 19, and the housing 30 in the space surrounded thereby are integrally displaceable in the short-side direction X. The terminal 10 includes, at the third leg portion 17, the width changing portion 17b at which the width of the terminal 10 in the long-side direction Y changes, and the width changing portion 17b is exposed from the housing 30.

In description below, a portion where the first leg portion 13, the first coupling portion 14, the second leg portion 15, and the housing 30 in the space surrounded thereby are integrally displaced may be referred to as a “first displacement portion.” Moreover, a portion where the third leg portion 17, the third coupling portion 18, the fourth leg portion 19, and the housing 30 in the space surrounded thereby are integrally displaced may be referred to as a “second displacement portion.”

According to the receptacle connector 2 described above, when the terminal 50 is inserted into the fitting recessed portion 10a of the terminal 10, the first displacement portion and second displacement portion of the terminal 10 are elastically displaced, and therefore, elastic force is generated from both the first displacement portion and the second displacement portion. Accordingly, sufficient contact pressure can be applied to the terminal 50 of the plug connector 3. In other words, the contact pressure to be applied can be enhanced. Thus, even when the receptacle connector 2 is reduced in size, the contact pressure to be applied to the terminal 50 of the plug connector 3 can be properly ensured. Consequently, for example, even when the connectors 2, 3 are repeatedly detached from and attached to each other, sufficient contact pressure can be continuously applied, and electric connection between the terminals 10, 50 of the connectors 2, 3 can be ensured. Moreover, in the present embodiment, since the width changing portion 17b at which the width of the terminal 10 in the long-side direction Y changes is exposed from the housing 30, the die can be pressed against the terminal 10 in the fitting direction Z at the width changing portion 17b. Thus, the receptacle connector 2 can be properly insert-molded.

Note that the features and effects of the present embodiment have been described above regarding the terminal 10 of the receptacle connector 2, but the receptacle connector 2 has not only the terminals 10 but also the terminals 20 and the terminal 20 has the configuration similar to that of the terminal 10. Thus, the terminal 20 can also provide features and effects similar to those of the terminal 10 as described above. For avoiding overlapping description, description of the features and effects of the terminal 20 will be omitted.

Similarly, the terminal 10 will be hereinafter described as a representative regarding the configurations, features, and effects common between the terminals 10, 20. Note that any of the terminal 10 and the terminal 20 will be specifically described regarding configurations, features, and effects unique to any of the terminal 10 and the terminal 20.

In the present embodiment, in the terminal 20, the second leg portion 25 is located closer to the mount portion 21 than the third leg portion 27, and has a greater amount of protrusion to the fitting recessed portion 20a side than that of the third leg portion 27. That is, the terminal 20 has the main contact point at the second leg portion 25 closer to the mount portion 21 out of the second leg portion 25 and the third leg portion 27. Thus, the fixed mount portion 21 is located in the vicinity of the second leg portion 25, so that the elastic force of a portion including the second leg portion 25 can be enhanced and contact pressure at the main contact point at the second leg portion 25 can be properly ensured.

In the present embodiment, the receptacle connector 2 has the plurality of terminals 10 arranged along the long-side direction Y, and the housing 30 has the long-side wall portions 31 to 36 holding the plurality of terminals 10. The long-side wall portions 31 to 36 have, between each adjacent ones of the plurality of terminals 10, the slits 31a to 36a extending in the fitting direction Z and the short-side direction X. With the slits 31a to 36a in the long-side wall portions 31 to 36, desired contact pressure can be properly ensured by the long-side wall portions 31 to 36 in just proportion. In this case, e.g., the sizes and shapes of the slits 31a to 36a may be designed such that the desired contact pressure (i.e., elastic force) can be ensured.

In the present embodiment, the receptacle connector 2 has the plurality of terminals 10 arranged along the long-side direction Y, and the plurality of terminals 10 is arranged such that the mount portions 11 of the terminals 10 adjacent to each other along the long-side direction Y are alternately located on the first short-side direction X1 side and the second short-side direction X2 side. Thus, the plurality of mount portions 11 arranged in the long-side direction Y can be alternately located on the first short-side direction X1 side and the second short-side direction X2 side. Consequently, a distance between adjacent ones of the mount portions 11 in the long-side direction Y can be ensured, and the plurality of mount portions 11 can be properly soldered.

In the present embodiment, the receptacle connector 2 has the plurality of terminals 10, 20 arranged along the short-side direction X, and the plurality of terminals 10, 20 is arranged such that the mount portions 11, 21 of the terminals 10, 20 adjacent to each other along the short-side direction X are located on the identical side in the short-side direction X. This restrains such arrangement that the mount portions 11, 21 arranged in the short-side direction X face each other. Thus, a distance between adjacent ones of the mount portions 11, 21 in the short-side direction X can be ensured, and the plurality of mount portions 11, 21 can be properly soldered.

In the present embodiment, the receptacle connector 2 has the plurality of terminals 10, 20 arranged along the long-side direction Y, and the plurality of terminals 10, 20 is arranged such that the leg portions having a greater amount of protrusion to the fitting recessed portion 10a, 20a side out of the second leg portions 15, 25 and the third leg portion 17, 27 are located on the identical side in the short-side direction X. Thus, in the plurality of terminals 10, 20 arranged in the long-side direction Y, the main contact points thereof can be located on the identical side in the short-side direction X.

In the present embodiment, the receptacle connector 2 has the plurality of terminals 10 arranged along the long-side direction Y, and the plurality of terminals 10 is arranged such that the leg portions having a greater amount of protrusion to the fitting recessed portion 10a side out of the second leg portions 15 and the third leg portions 17 are alternately located on the first short-side direction X1 side and the second short-side direction X2 side in the terminals 10 adjacent to each other in the long-side direction Y. Thus, in the plurality of terminals 10 arranged in the long-side direction Y, the main contact points thereof can be alternately located on the first short-side direction X1 side and the second short-side direction X2 side.

In the present embodiment, each of the second leg portion 15 and the third leg portion 17 is configured such that the portions 15c, 17c of the pair of side surfaces facing each other in the long-side direction Y are exposed from the housing 30. Thus, the die can be pressed against the terminal 10 in the long-side direction Y at the portions 15c, 17c of the side surfaces of the second leg portion 15 and the third leg portion 17, and the receptacle connector 2 can be properly insert-molded.

Note that the above-described embodiment is an example for describing the present disclosure and the present disclosure is not limited thereto. The present disclosure can be implemented in various forms without departing from the gist thereof.

The electric connector according to the present disclosure can be used for, e.g., connecting boards through a flat cable in electronic equipment, such as a smartphone or a mobile phone, for high-speed electric signal transmission.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electric connector comprising:
a terminal; and
a housing holding the terminal,
wherein the terminal has a first leg portion, a second leg portion, a third leg portion, a fourth leg portion, an extending portion, a first coupling portion, a second coupling portion, a third coupling portion, a mount portion, a fitting recessed portion, and a width changing portion,
the first leg portion, the second leg portion, the third leg portion, and the fourth leg portion are provided apart from each other in an order of the first leg portion, the second leg portion, the third leg portion, and the fourth leg portion along a short-side direction of the electric connector, and each extend in a first fitting direction which is a fitting direction of fitting the electric connector in a partner connector,
the extending portion is connected to an end portion of the first leg portion on a second fitting direction side which is opposite to a first fitting direction side, and extends in the short-side direction,
the first coupling portion extends in the short-side direction, and connects an end portion of the first leg portion on the first fitting direction side and an end portion of the second leg portion on the first fitting direction side to each other,
the second coupling portion extends in the short-side direction, and connects an end portion of the second leg portion on the second fitting direction side and an end portion of the third leg portion on the second fitting direction side to each other,
the third coupling portion extends in the short-side direction, and connects an end portion of the third leg portion on the first fitting direction side and an end portion of the fourth leg portion on the first fitting direction side to each other,
the mount portion is provided at an outer surface of the extending portion on the second fitting direction side,
the housing is configured to fill a space surrounded by the first leg portion, the first coupling portion, and the second leg portion of the terminal and to fill a space surrounded by the third leg portion, the third coupling portion, and the fourth leg portion of the terminal,
the fitting recessed portion is configured such that a terminal of the partner connector is receivable by a recessed portion formed by the second leg portion, the second coupling portion, and the third leg portion,
the terminal is configured such that when the terminal of the partner connector is inserted into the recessed portion, the terminal of the partner connector contacts the second leg portion and the third leg portion, and accordingly, the first leg portion, the first coupling portion, the second leg portion, and the housing in the space surrounded by the first leg portion, the first coupling portion, and the second leg portion are integrally displaceable in the short-side direction and the third leg portion, the third coupling portion, the fourth leg portion, and the housing in the space surrounded by the third leg portion, the third coupling portion, and the fourth leg portion are integrally displaceable in the short-side direction, and
the width changing portion is provided at least one of the second leg portion or the third leg portion so as to be exposed from the housing, and is configured such that a width of the terminal in a long-side direction of the electric connector changes at the width changing portion.

2. The electric connector according to claim 1, wherein
each of the second leg portion and the third leg portion has a curved portion protruding to a fitting recessed portion side, and
the second leg portion is located closer to the mount portion than the third leg portion, and is configured such that an amount of protrusion of the curved portion of the second leg portion to the fitting recessed portion side is greater than an amount of protrusion of the curved portion of the third leg portion to the fitting recessed portion side.

3. The electric connector according to claim 1, wherein
the terminal includes a plurality of terminals arranged along the long-side direction,
the housing has a wall portion extending in the long-side direction and holding the plurality of terminals, and
the wall portion has, between each adjacent ones of the plurality of terminals, a slit extending in the fitting direction and the short-side direction.

4. The electric connector according to claim 1, wherein
the terminal includes a plurality of terminals arranged along the long-side direction, and
the plurality of terminals is arranged such that the mount portions of the plurality of terminals adjacent to each other are alternately located on one direction side in the short-side direction and a side opposite to the one direction side.

5. The electric connector according to claim 1, wherein
the terminal includes a plurality of terminals arranged along the short-side direction, and
the plurality of terminals is arranged such that the mount portions of the plurality of terminals adjacent to each other are located on an identical side in the short-side direction.

6. The electric connector according to claim 1, wherein
the terminal includes a plurality of terminals arranged along the long-side direction,
each of the second leg portion and the third leg portion has a curved portion protruding to a fitting recessed portion side, and
the plurality of terminals is arranged such that leg portions having a greater amount of protrusion of the curved portion to the fitting recessed portion side out of the second leg portions and the third leg portions are located on an identical side in the short-side direction.

7. The electric connector according to claim 1, wherein
the terminal includes a plurality of terminals arranged along the long-side direction,
each of the second leg portion and the third leg portion has a curved portion protruding to a fitting recessed portion side, and
the plurality of terminals is arranged such that leg portions having a greater amount of protrusion of the curved portion to the fitting recessed portion side out of the second leg portions and the third leg portions are alternately located on one direction side in the short-side direction and a side opposite to the one direction side in the terminals adjacent to each other in the long-side direction.

8. The electric connector according to claim 1, wherein
each of the second leg portion and the third leg portion is configured such that portions of a pair of side surfaces facing each other in the long-side direction are exposed from the housing.

9. An electric connector comprising:
a housing; and
a plurality of terminals,
wherein the housing has a first wall portion, a second wall portion, and a third wall portion,
the first wall portion, the second wall portion, and the third wall portion are arranged apart from each other in an order of the first wall portion, the second wall portion, and the third wall portion along a short-side direction of the electric connector, and each extend in a long-side direction of the electric connector,
the plurality of terminals is held by the first wall portion, the second wall portion, and the third wall portion of the housing, and provided to be arranged apart from each other along the long-side direction,
each of the plurality of terminals has two leg portions, a coupling portion, a fitting recessed portion, and a mount portion,
the two leg portions are each held by housing, extend in a fitting direction of fitting the electric connector in a partner connector, and are provided apart from each other along the short-side direction, the coupling portion extends in the short-side direction to connect end portions of the two leg portions to each other, the fitting recessed portion is configured such that a terminal of the partner connector is receivable by a recessed portion formed by the two leg portions and the coupling portion, and the mount portion is provided at an end portion of the terminal in the short-side direction,
when the terminal of the partner connector is inserted into the fitting recessed portion, one of the two leg portions and a portion of the housing holding the one of the two leg portions are integrally displaceable in the short-side direction, and the other one of the two leg portions and a portion of the housing holding the other one of the two leg portions are integrally displaceable in the short-side direction,
the electric connector includes
a first line in which the plurality of terminals having the mount portions on a first short-side direction side in the short-side direction is provided in the first wall portion along the long-side direction,
a second line in which the plurality of terminals having the mount portions on a second short-side direction side opposite to the first short-side direction side is provided in the first wall portion along the long-side direction,
a third line in which the plurality of terminals having the mount portions on the first short-side direction side is provided in the second wall portion along the long-side direction,
a fourth line in which the plurality of terminals having the mount portions on the second short-side direction side is provided in the second wall portion along the long-side direction,
a fifth line in which the plurality of terminals having the mount portions on the first short-side direction side is provided in the third wall portion along the long-side direction, and
a sixth line in which the plurality of terminals having the mount portions on the second short-side direction side is provided in the third wall portion along the long-side direction, and
the plurality of terminals provided in each of the first wall portion, the second wall portion, and the third wall portion is arranged such that the mount portions of the terminals adjacent to each other in the long-side direction are alternately located on the first short-side direction side and the second short-side direction side.

10. A connector assembly comprising:
a first connector which is the electric connector according to claim 1; and
a second connector fittable in the first connector,
wherein the second connector has a terminal inserted into the fitting recessed portion of the terminal of the first connector and electrically connected to the terminal of the first connector.
